(19) United States
(12) Patent Application Publication
(10) Pub. No.: US 2026/0139532 A1
(43) Pub. Date: May 21, 2026

(54) DOOR STOPPER

(71) Applicant: Herschy Sofer, Brooklyn, NY (US)

(72) Inventor: Herschy Sofer, Brooklyn, NY (US)

(21) Appl. No.: 18/955,394

(22) Filed: Nov. 21, 2024

(51) Int. Cl. E05C 17/56

(52) U.S. Cl. CPC E05C 17/56

(57) ABSTRACT

The present system is related to a door stopper assembly. The door stopper includes a sheath and a corresponding pin that slides within the sheath. A magnet may be used to extract the pin from the sheath. However, the pin and sheath are formed such that the opening of the sheath cavity is smaller than the diameter of the cavity along the length of the cavity and a flange of the pin is greater in diameter than the diameter of the opening. Thus the flange of the pin and a circumferential lip of the cavity contact each other to prevent the pin from being fully extracted from the cavity through the opening of the cavity.

### BACKGROUND

Magnetic door stoppers are readily available. They are constructed in multiple parts. There is a magnet and strike plate. The magnet is sunk in the bottom of a door, strike plate is affixed to the bottom of the door over the magnet thereby preventing the magnet from falling out of the door. A sheath is sunk in the floor and a ferrous rod is slid or dropped into the sheath. When the door swings over the rod, the magnet lifts the rod which contacts the strike palate and stops the door. With additional force applied to the door, the magnetic force is overcome, the door swings free, and the rod falls back into the sheath.

The problem is that the ferrous rod may easily be separated from the sheath. Because the rod simply slips into the sheath, there is nothing except gravity keeping the rod within the sheath. Thus, in the event that a magnet is passed over the rod while the door is open, the rod will slide free and be lost. Similarly, a vacuum cleaner that passes over the sheath and rod may suck the rod out of the sheath unbeknownst to the operator, and thereafter may be discarded or lost entirely.

### SUMMARY

The present system provides an alternative structure for a door stopper that prevents the rod from being disconnected from the sheath and thereby prevents loss of the rod.

The present system includes a magnet and strike plate that are affixed to the underside of a door. The sheath is formed of a tubular portion having a hollow cavity. The cavity includes multiple internal diameters. The diameter at the top of the cavity is less than the diameter along the length of the cavity. A rod is formed that fits within the cavity. The rod has multiple diameters. The majority of the length of the rod is less than the smaller diameter at the top of the cavity. This allows the rod to slide up and down within the smaller diameter portion of the cavity. At the bottom of the rod, there is a flange where the diameter of the flange is larger than the smaller diameter at the top of the cavity, but less than the diameter along the length of the cavity. In this way, the rod is adapted to be drawn up through the smaller diameter of the cavity such that a portion of the rod protrudes from the sheath until the flange reaches the smaller diameter of the cavity and is thus stopped from progressing further. In this way, the rod cannot be pulled free of the sheath through the top of the sheath.

To fit the rod within the sheath, the sheath may have an open bottom that is at least as large in diameter as the diameter of the flange. However, in an embodiment with an open bottom, if the depth of the mounting hole in the floor is not properly fit (for example it is deeper than the sheath), the rod can fall too deep into the floor and the flange may become blocked by the bottom of the sheath rather than sliding smoothly within the cavity. There is also a risk that the rod becomes detached from the sheath prior to inserting the sheath into the floor.

In alternate embodiments, the sheath is formed of two parts. In one embodiment, the bottom of the sheath is open, thereby accommodating the rod. A plug is then fitted to the bottom, blocking the rod from sliding out through the bottom.

In an alternate embodiment, the sheath is formed of two halves. The rod may be placed in a first half and the second half may then be joined to the first half, such as by snap fit engagement. This forms the completed sheath with a bottom and open top that allows the rod to slide within the cavity but cannot slide fully out of the top or out of the bottom of the sheath.

### BRIEF DESCRIPTION OF DRAWINGS

FIG. 1 is a front view depiction of the door stopper system.

FIG. 2 is a depiction of a cross-section of the front view of the door stopper system shown in FIG. 1.

FIG. 3 is a depiction of a cross-section of the door stopper system from a side-view.

FIG. 4 is a perspective view of the strike plate.

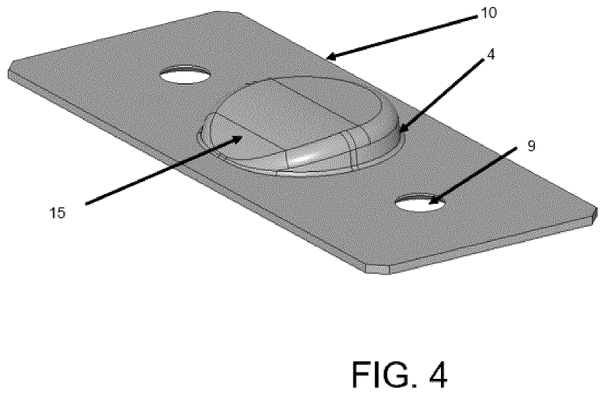

FIG. 5 is a cross-section view of the sheath of the door stopper system.

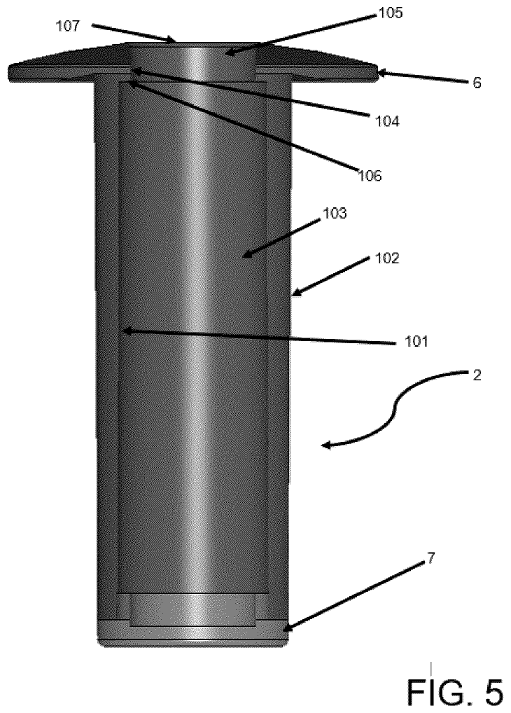

FIG. 6 is an enlarged cross-section view of the top of the sheath of the door stopper system.

FIG. 7 is a cross-section view of the pin.

FIG. 8 is a cross-section view of the sheath and pin with the pin in a fully extended position.

FIG. 9 is a cross-section view of the sheath and pin with the pin in a fully retracted position.

### DETAILED DESCRIPTION

Throughout the specification, wherever practicable, like structures will be identified by like reference numbers. Unless expressly stated otherwise, the term “or” means “either or both” such that “A or B” includes A alone, B alone, and both A and B together. “Approximately” as used herein means rounding to a scientifically significant figure.

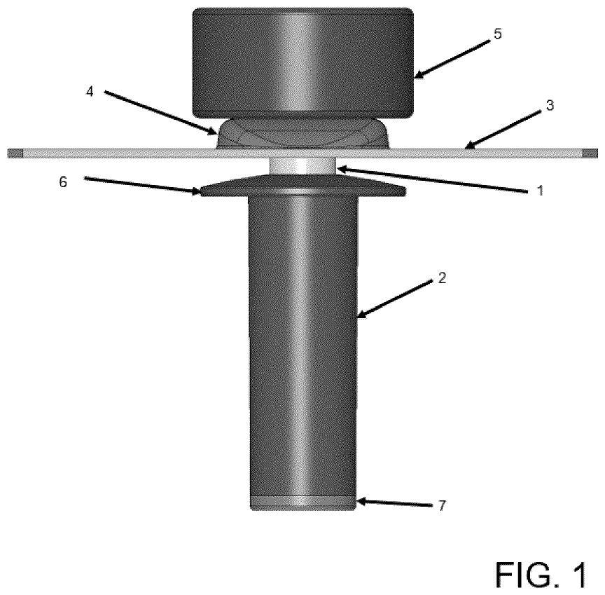

FIG. 1 is a depiction of the door stopper assembly. It includes the pin 1, sheath 2, a strike plate 3 that has receiving compartment 4, and a magnet 5. The sheath may include a flange 6 and a base plug 7. In operation, the magnet is sunk in the bottom of a door and the strike plate is affixed to the door over the magnet such that the strike plate blocks the magnet from falling out of the bottom of the door and such that the magnet is positioned over the receiving compartment. The sheath and pin assembly is sunk in the floor in a location where, when the door is swung on its hinges, the door and magnet sweep over the pin, the magnet attracts the pin, and the pin enters the receiving cavity and stops the motion of the door.

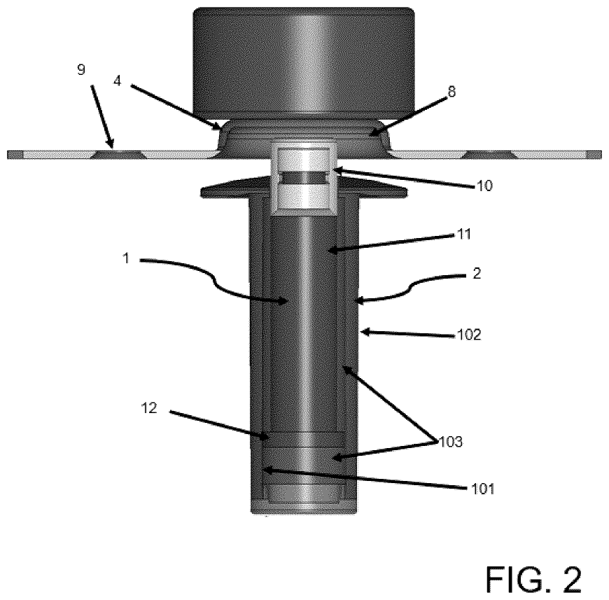

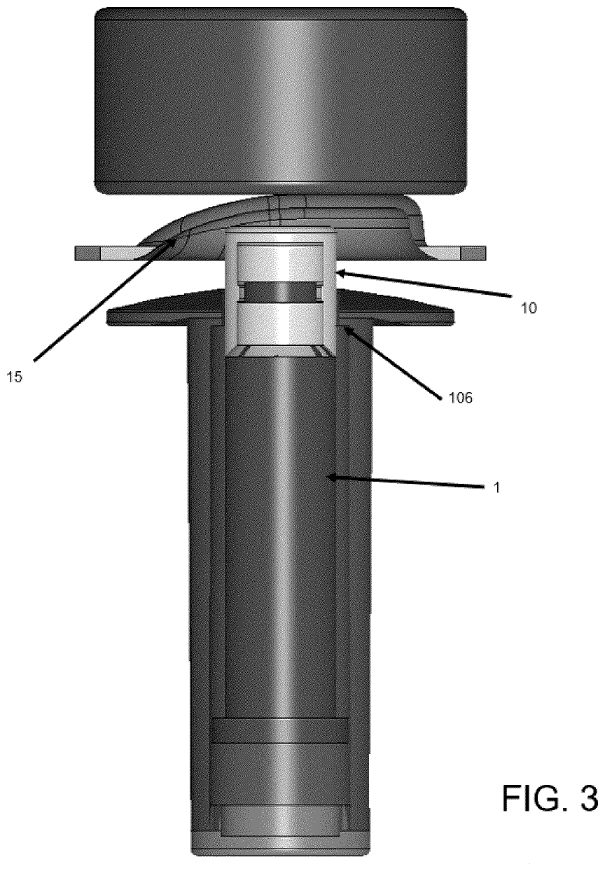

FIG. 2 shows a cross-sectional view of the door stopper assembly. The receiving compartment 4 of the strike plate forms cavity 8 into which the pin enters when attracted by the magnet. Mounting holes 9 allow for screws to mount the strike plate to the bottom of the door. As shown in FIG. 3, the receiving compartment is shaped such that a sloped portion 15 is provided on one side of the receiving compartment. This facilitates release of the door from the pin.

The pin 1 may be formed of a solid machined rod of magnetically reactive material (such as iron or iron alloy), or may be formed of separate parts. In the example depicted the rod is formed of shaft 11, cap 10, and base flange 12. The cap and base flange may be mechanically connected, directly or indirectly to the shaft or may be integrated with the shaft or any combination of the foregoing but in all such cases the shaft, cap, and flange are considered to be connected. At least one, and in some embodiments both, of the shaft and cap is a magnetically reactive material. The base flange extends out from the outer circumference of the pin. Thus the diameter of the pin shaft 11 is less than the diameter of the flange 12.

The sheath 2 is formed of an overall body that has a length that is greater than its width and that includes an inner wall 101 and outer wall 102. The inner wall forms a cavity 103. As shown in FIG. 2, the cavity is cylindrical and accommodates the pin 1. The outer wall 102 is also cylindrical, though it could have other shapes as could the cavity so long as the cavity accommodates the pin.

The diameter of the sheath cavity 103 is approximately the same as the diameter of the base flange of the pin, though slightly larger such that the pin is allowed to smoothly slide up and down the length of the sheath within the cavity. For example, the cavity may have a diameter that is approximately 0.5 to 1 millimeters larger than the diameter of the base flange. Essentially the relative diameters are such that the pin is capable of sliding within the cavity without touching the inner sidewall when the temperature is between 60 and 80 degrees Fahrenheit, and preferably within 0 and 115 degrees Fahrenheit.

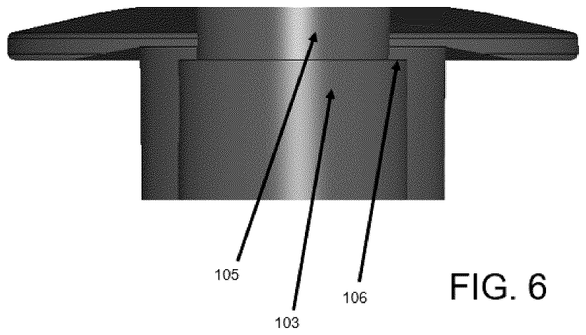

FIG. 6 is an enlarged view of the upper portion of the sheath. Toward the top of the sheath, the inner wall extends inward and forms a circumferential lip 106 that further forms a circumferential opening wall 104 that defines opening cavity 105 and opening 107. Thus the diameter of opening 105 is less than the diameter of cavity 103. The diameter of the opening 105 is approximately the same as the diameter of the pin shaft 11. Essentially the relative diameters are such that the pin shaft is capable of sliding within the opening 105 without touching the inner sidewall of the opening 105 when the temperature is between 60 and 80 degrees Fahrenheit, and preferably within 0 and 115 degrees Fahrenheit. However, the diameter of the opening 105 is less than the diameter of the base flange 12.

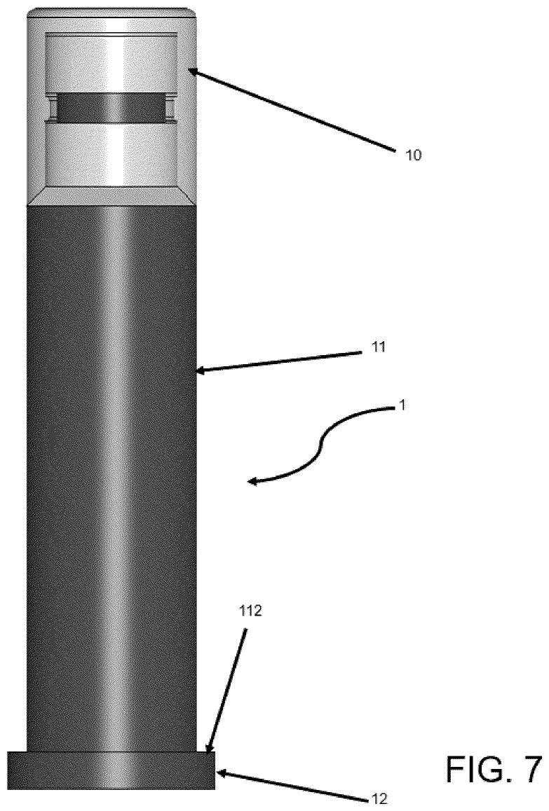

FIG. 7 is a depiction of the pin. The pin 1 may include cap 10 affixed to shaft 11. The pin includes base flange 12 that extends from the base of the pin. The extending base flange forms the pin lip 112. Thus, the diameter of the base flange is greater than the diameter of the shaft 11. In one embodiment, the diameter of the base flange is 1-2 millimeters greater than the diameter of the shaft 11.

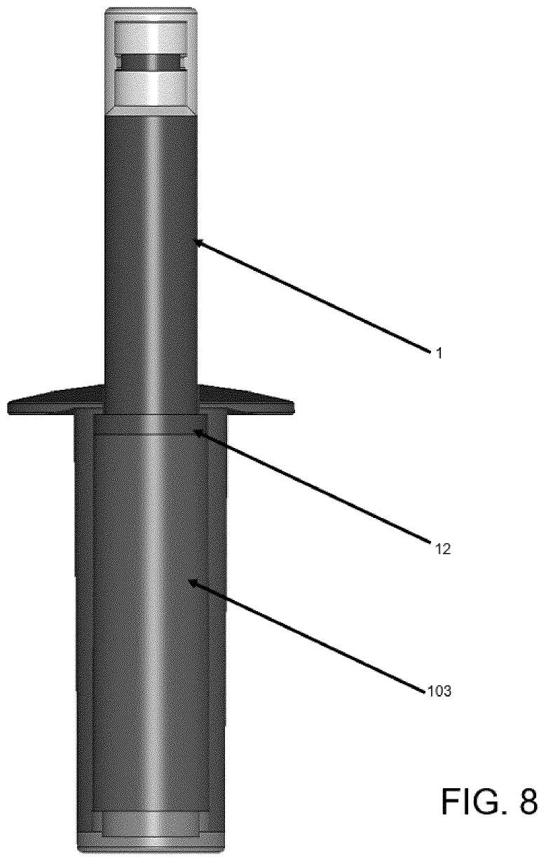

FIG. 8 depicts the pin in an extended position. Due to the structures of the circumferential lip 106 of the sheath, and the flange 12 of pin, when the pin is fully extended, pin lip 112 of the flange contacts circumferential lip 106 which stops the pin from exiting the cavity and becoming fully detached from the sheath. This way, regardless of the orientation of the sheath and even when a magnet or suction is applied to the pin, the pin is prevented from fully exiting the cavity of the sheath.

Because the flange is too large to fit through the opening 105, the pin may be inserted into the cavity through the bottom of the sheath. The bottom of the sheath may be open to allow for the insertion of the pin. Additionally, a plug 7 may be fitted or integrated into the bottom of the sheath after the pin is inserted.

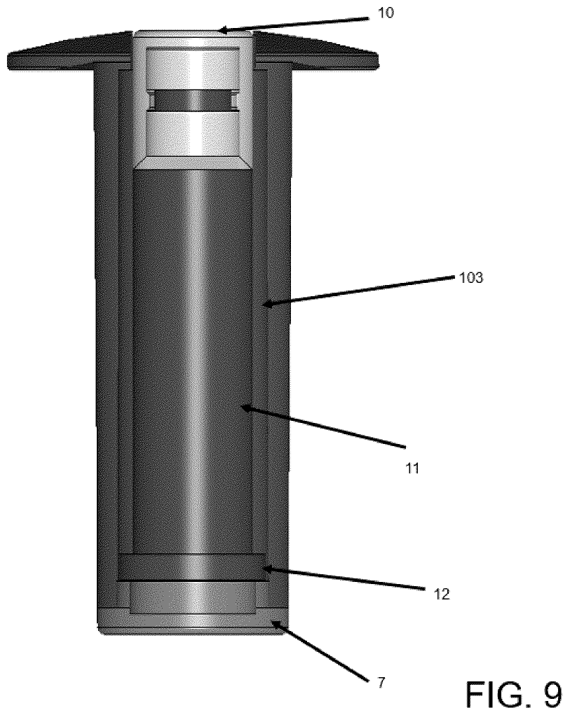

As shown in FIG. 9, the plug may close off the bottom in part or in full and thereby stop the pin from exiting the cavity of the sheath through the bottom of the sheath. Additionally, the pin has a length from the top of the cap to the bottom of the base flange. The length of the cavity of the sheath extends from the bottom of the cavity (which in FIG. 9 is the uppermost portion of the plug 7 on which the base flange of the pin is depicted as resting) to the circumferential lip 106. As shown, the length of the pin is greater than the length of the cavity. Because the diameter of the pin shaft and cap are less than the diameter of the cavity, keeping the pin longer than the cavity prevents the pin from falling into the cavity and becoming lodged against the bottom of the circumferential lip. Alternatively, the cap of the pin may be flared or the top of the cap may be extended laterally to increase its diameter to be greater than the diameter of the opening and thereby prevent the pin from falling too deeply into the cavity. In the later formation, the pin may be inserted into the bottom of the cavity, extended out of the opening, and the flared (or larger) cap may be secured to the tip of the pin (or alternatively the tip of the pin may be manipulated, such as by hammering, to flare it out). In an alternate embodiment the sheath may be formed of two longitudinal halves. The pin may be placed in one half such that the base flange is set within the cavity (and if the tip of the pin or cap of the pin is lager than the opening, the tip may be positioned extended from the opening) and thereafter the second have may be fitted to or secured to the first half to enclose the based flange of the pin within the cavity.

For explanatory purposes the sheath and pin have been described in terms of being cylindrical. However, it will be apparent to persons of skill in the art that other shapes could be used. In the instance of other shapes, the term “diameter” should be understood to be a maximum measurement of the cross section of the shape. Thus, for a circle, the diameter is the generally accepted meaning of circular diameter, but for a square, for example, the “diameter” would be the straight-line distance between two non-adjacent vertices.

Although the present invention has been described in terms of various embodiments, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

1. A door stopper assembly comprising:
A magnet, a sheath, and a pin;
the sheath comprising:
a body having an inner wall that surrounds a cavity, a diameter of the cavity being defined by the inner wall, and a length;
the inner wall including a circumferential lip that extends into the cavity and forms an opening wall and opening cavity having an opening diameter that is less than the diameter of the cavity
the pin comprising:
a shaft having a shaft diameter and a base flange having a base flange diameter that is greater than the shaft diameter;
the base flange is connected to an end of the shaft; and
at least a portion of the pin is magnetically reactive;
wherein the base flange diameter is greater than the opening diameter.

2. The door stopper assembly of claim 1, wherein a portion of the pin including the base flange is positioned within the cavity of the sheath such that the pin is adapted to slide along the length of the sheath and a portion of the pin is adapted to extend out of the sheath through the opening.

3. The door stopper assembly of claim 1, wherein the sheath includes a base plug.

4. The door stopper assembly of claim 1, wherein the cavity has a length that extends from a bottom of the sheath to the circumferential lip and the pin has a total length that is greater than the length of the cavity.

5. The door stopper assembly of claim 1, wherein the pin includes a tip wherein a portion of the tip has a greater diameter than a diameter of the cavity at the circumferential lip.

6. The door stopper assembly of claim 4, further including a base plug that prevents the pin from exiting a bottom portion of the cavity.
